(19) United States
(12) Patent Application Publication
(10) Pub. No.: US 2001/0021947 A1
(43) Pub. Date: Sep. 13, 2001

(54) Method for searching for domain in internet

(76) Inventor: Se Ki Kim, Hwasung (KR)

Correspondence Address: Jonathan Y. Kang, Esq., Lee & Hong P.C., 11th Floor, 221 N. Figueroa Street, Los Angeles, CA, 90012-2601, US

(21) Appl. No.: 09/800,898

(22) Filed: Mar. 7, 2001

(30) Foreign Application Priority Data
Mar. 8, 2000 (KR) 2000-11516

(51) Int. Cl. G06F 15/16; G06F 15/173

(52) U.S. Cl. 709/217; 709/223; 709/229

(57) ABSTRACT

The present invention relates to a method for searching for a domain in internet which indicates a plurality of related domain names including a searched domain in alphabetic or numeric order in registering a domain name or searching for information, so as to permit a user to verify those easily. The method for searching for domain according to the present invention comprising: (a) building a search service site and leading an administrator of many other site to register a certain domain name; (b) requesting a search by entering the domain name as a key word in a domain search engine after an Internet user is connected to the search service site built in the step(a); (c) verifying whether the domain name in the step (b) is included in all domain names registered in the step (a); and (d) indicating all related domain names in alphabetic or numeric order including the domain having the key word in the step (c).

### BACKGROUND OF THE INVENTION

1. Field of the Invention

The present invention relates to a method for searching for a domain in internet, more specifically the method for searching for the domain in internet, which searches for domain names of related site in registering a domain name or searching for information and indicates a plurality of searched domain names in alphabetic or numeric order, so as to permit a user to verify those easily.

2. Background of the Related Art

Recently, an internet communication is achieved through cellular phones as well as computers and television sets, and the number of internet-connected peoples are estimated at about one hundred and fifty million or two hundred million and tends to increase continuously.

As the number of Internet users increases rapidly, various services using a internet network is activated and among them an electronic commerce, advertising and information providing is most popular.

For the above various services, a certain domain name is registered (obtained) in a domain registration authority or a domain registration service site, an internet site having the registered domain name is built and managed, and the domain name is also registered in a search service site or a search engine to advertise the managed site.

At present, many domain registration authority and domain registration service site are exist, and there are, for example KRNIC (www.nic.or.kr), NSI (www.nsi.com), namekorea.com (www.namekorea.com), and whois (www.whois.co.kr).

Also, many search service site, that is search engines are exist, and there are, for example Yahoo (www.yahoo.com), Simmani (www.simmani.com), Lycos (www.lycos.com), and daum (www.daum.net).

However, since only a pre-registration of a specific domain name entered in searing the domain names and information regarding a registration possibility of a searched specific domain are indicated in the domain registration authority and domain registration service site and registration information of similar domain related to the searched domain name is not indicated, it is difficult to understand a registration state of the similar or related domain.

Also, although the search service site searches for required sites and indicates search results using a key word or sentence, the search results varies including a part of contents in the site, a company name managing the site, or a name of a certain person so that its indication standard is vague and the search results are indicated in order of a directory classified by the its administrator so that it is difficult to understand and sort its classification standard.

More specifically, the result contents are listed based on an arbitrary classification standard determined by an administrator of each search service site, such as a region, business, or entered (registered) time, so that the user is ready to suffer for wasting time and inconvenience to understand and utilize its classification standard. Especially, it is even difficult for user to search for a directory suitable for a new registration and a directory in which his or her site is registered after the registration.

In addition, since the search service site attempts to classify sites increasing in geometric progression by various contents categories, there is a limitation to classify a variety of increased contents substantially and there are many difficulties for the registration in suitable directory. With these problems, one site is even registered in a plurality of directories of some search engine.

### SUMMARY OF THE INVENTION

The present invention is contemplated to solve the aforementioned problem, and it is an object of the present invention to provide a method for searching for a domain in Internet, which lists a search result in the Internet, based on not a general information classification method but a domain name so that a classification standard is clarified.

It is another object of the present invention to provide the method for searching for the domain in Internet, which provides an apparent standard by indicating the search result in alphabetic or numeric order, so that users perform a search procedure easily in the search for the domain registration or in the search for information in many search service site.

It is still another object of the present invention to provide the method for searching for the domain in Internet, which indicates a plurality of related domain manes in alphabetic or numeric order to be divided apparently using an distinct order which the alphabet or numeral have, so that similar or related site is understood easily.

It is yet another object of the present invention to provide the method for searching for the domain in Internet, which causes administrators of each site to enter an index word together with the domain name in registering related sites in the search service site, and searches all domain names including the index word and indicates the searched domain names in alphabetic or numeric order, so that the users verify a plurality of sites more easily.

To accomplish the above object, according to the first aspect of the present invention it is provided the method for searching for domain comprising: (a) building a search service site and leading an administrator of many other site to register a certain domain name; (b) requesting a search by entering the domain name as a key word in a domain search engine after an Internet user is connected to the search service site built in the step (a); (c) verifying whether the domain name in the step (b) is included in all domain names registered in the step (a); and (d) indicating all related domain names in alphabetic or numeric order including the domain having the key word in the step (c).

Meanwhile, according to the second aspect of the present invention, it is provided the method for searching for domain comprising: (a) building a search service site and leading an administrator of many other site to register a certain domain name and enter a plurality of index words including a characteristics of own site in the registration; (b) requesting a search by entering the index word in the search engine after an Internet user is connected to the search service site built in the step (a); (c) verifying whether the index word in the step (b) is included in the index words registered in the step (a); and (d) indicating all related domain names including the index word in the step (c) in alphabetic or numeric order.

Preferably, the step (b) in the first and second aspect of the present invention, includes requesting the search by click of a hyperlink.

According to the third aspect of the present invention, it is provided the method for searching for domain comprising: (a) entering a registration required domain name in a search window of a domain registration authority or domain registration service site to verify a pre-registration of the required domain name; (b) indicating a message informing of a registration possibility or a pre-registration of the domain names entered in the step (a) in the domain registration authority or domain registration service site; and (c) indicating all related domain names in alphabetic or numeric order including the domain having the key word in the step (a) from date of the domain registration authority or domain registration service site.

### BRIEF DESCRIPTION OF THE DRAWINGS

The features and advantages of the present invention will be more described specifically in the following description of preferred embodiments of the invention with reference to the accompanying drawings wherein:

FIG. 1 is a flow chart showing a registration procedure in a domain registration authority or a domain registration service site according to the present invention;

FIG. 2 is a view showing an example for entering a domain name in a search window in order to verify a previous registration of a desired domain name in registering the domain name according to the present invention;

FIG. 3 is a view showing an example for indicating related domain names registered previously on a screen in the search of the domain names through a step in FIG. 2 according to the present invention;

FIG. 4 is a flow chart showing a management procedure of a search service site according to the present invention;

FIG. 5 is a view showing an example for entering a keyword in a search engine of the domain registration authority, the domain registration service site, and the search service site according to the present invention;

FIG. 6 is a view of an example for performing a search using a hyperlink according to the present invention;

FIG. 7 is a view showing an example for indicating a result of the domain search in FIG. 5 or FIG. 6 according to the present invention;

FIG. 8 is a view showing an example for entering an index word in a search window in searching using the index word according to the present invention; and

FIG. 9 is a view showing an example for indicating a domain on a screen in searching using the index word in FIG. 8 according to the present invention.

### DETAILED DESCRIPTION OF THE PREFERRED EMBODIMENT

Reference will now be made in detail to the embodiment of the present invention and examples of which are illustrated in the accompanying drawings. In explaining the present invention, the same names and reference numerals will be given to the same components, and explanations in the same will be omitted.

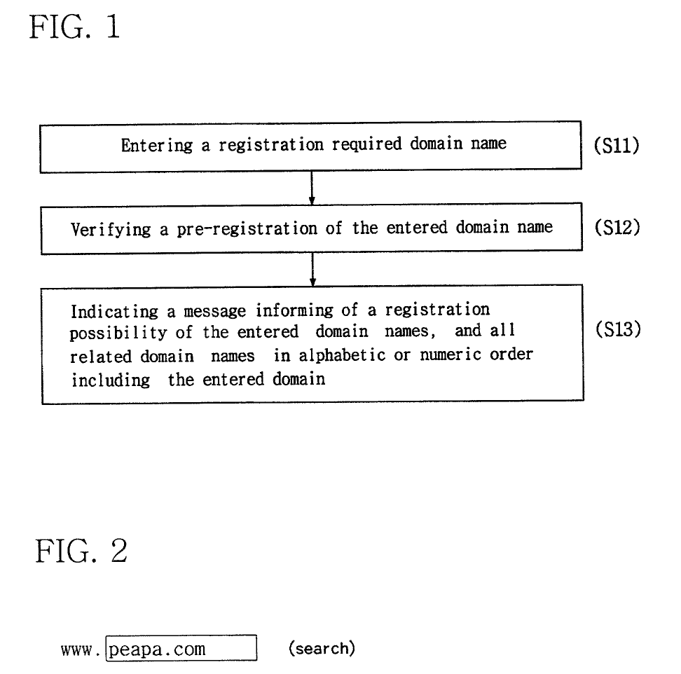

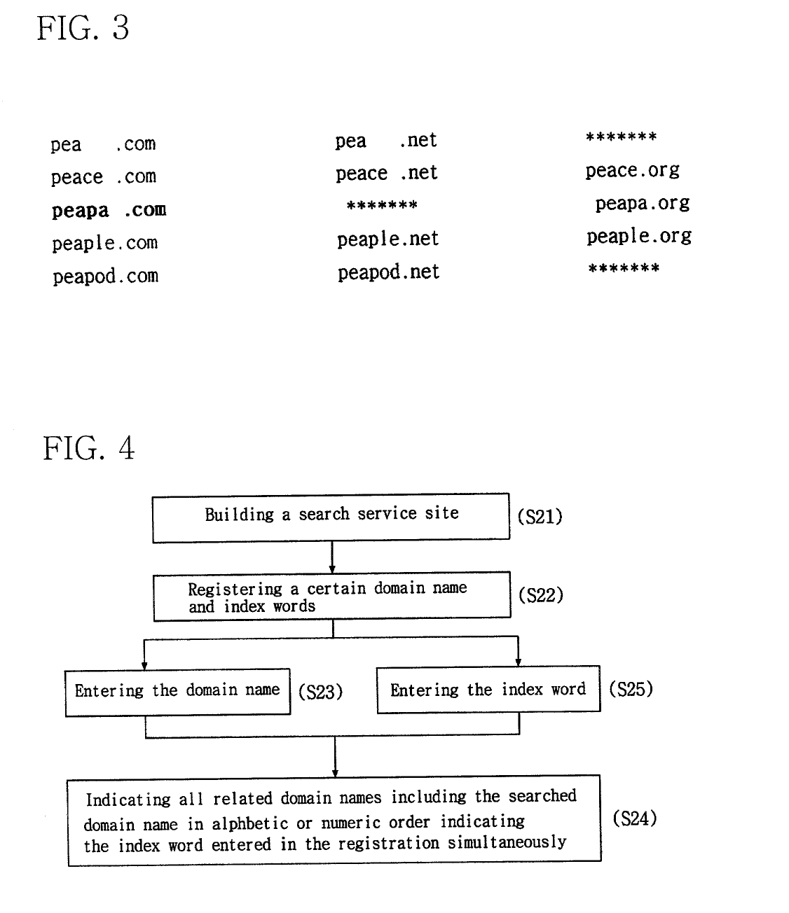

FIG. 1 illustrates a flow chart showing a registration procedure in a domain registration authority or a domain registration service site according to the present invention, FIG. 2 illustrates a view showing an example for entering a domain name in a search window in order to verify a previous registration of a desired domain name in registering the domain name according to the present invention, and FIG. 3 illustrates a view showing an example for indicating a corresponding domain and related domain names in alphabetic or numeric order on a screen in the search of the domain names through a step in FIG. 2 according to the present invention.

Referring to accompanying FIG. 1, firstly a person who wants to register (obtain) a domain name is connected to a domain registration authority or domain registration service site and enters a desired domain name as shown in FIG. 2 (S11).

Then, a pre-registration of the domain name is verified from related data (S12). If the entered and searched domain is not registered, a message which informs of the possibility of the registration is indicated, and if the entered domain name is registered previously, a message which informs of the impossibility of the registration is indicated, a plurality of domain names related in alphabetic and numeric order are called out and indicated including the entered domain name (S13).

In the above, a duplication regarding each top-level domain (for example, com, net, org, and the like) is searched for, and a part not be registered is indicated as asterisks “******”. A top-level domain ‘com’ is an abbreviation for ‘company’, ‘net’ is an abbreviation for ‘network’, and ‘org’ is an abbreviation for ‘organization’. Except for these, various types of top-level domain is considered for use according to a request for new domains and nations.

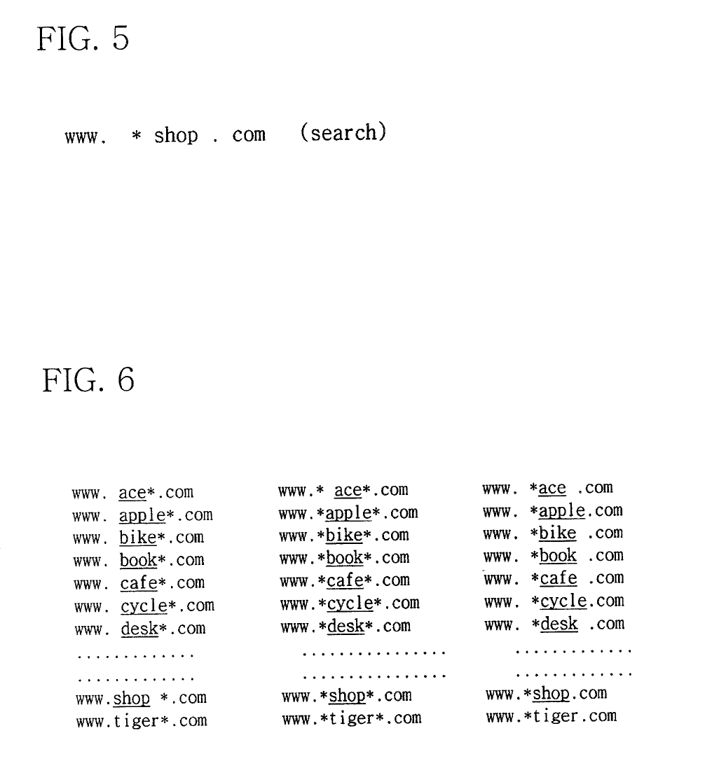

Meanwhile, FIG. 4 illustrates a flow chart showing a management procedure of a search service site according to the present invention, FIG. 5 illustrates a view showing an example for entering a keyword in a search engine according to the present invention, and FIG. 6 is a view of an example for performing a search using a hyperlink according to the present invention.

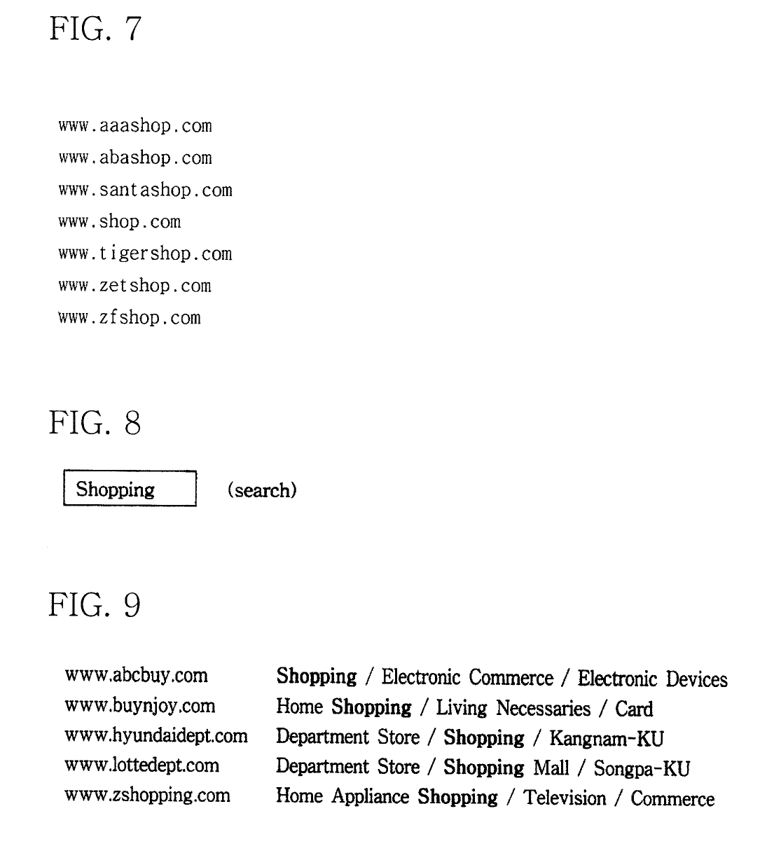

Also, FIG. 7 illustrates a view showing an example for indicating a result of the domain name search in FIG. 5 or FIG. 6 on a screen according to the present invention, FIG. 8 illustrates a view showing an example for entering an index word in a search window in searching using the index word according to the present invention, and FIG. 9 illustrates a view showing an example for indicating a domain on a screen in searching using the index word in FIG. 8 according to the present invention.

Referring to FIG. 4, an administrator builds the search service site (S21), leads administrators of many other sites to register a certain domain name (S22). In the above, it is preferable to request to enter a plurality of representative index words in order to search for own site easily, in the registration of the domain name in other sites. In this procedure, the registration procedure described above (S22) is performed.

After the search service site is built through the above steps, the Internet user is connected to the search site and then requests a search by entering a part or whole domain name as a key word in the search engine as shown in FIG. 5 (S23).

Also, as shown in FIG. 8, the user requests a search by entering an index word (S25).

Generally, since the domain name uses characteristic words, which means information provided in the sites or a purpose of sites, the user obtains required information or finds a required site by entering characteristic words of a required field as the key word.

For an example, it is preferable for users to enter “shop” as the key word to find an electronic commerce site. As shown in FIG. 5, “*shop” is entered in the search window, all domain names which includes a word “shop” in an end thereof, is searched for.

Alternatively, as shown in FIG. 6, one of many hyper link such as “www.*shop.com” is selected and clicked, and then all domain names which includes a word “shop” in an end thereof, is searched for.

Meanwhile, in the present invention not only one key word but also many key words are entered at the same time, and then the domain name including all key words could be searched for.

When the search is requested as the above, the search service site verifies whether the entered key word exists in the registered domain names, and indicates all domain names including the key word in alphabetic and numeric order as shown in FIG. 7 and FIG. 9 (S24).

Alternatively, the present invention enables the index word search in addition to the domain search, so as to perform a search by entering the index word in the search window as shown in FIG. 8 and indicate a plurality of domain names in alphabetic and numeric order after the search of the domain names including the index word as shown in FIG. 9. Additionally, many registered index words, which represent the characteristics of the site having the searched domain name.

That is, FIG. 7 illustrates the search result regarding all domain names which includes a word “shop” in an end thereof as shown in FIG. 5 and FIG. 6. FIG. 9 illustrates the result by entering the index word such as “shopping” as shown in FIG. 8 and indicating domain names including “shopping” in the representative index word, which registered by the administrator previously, as shown in FIG. 9.

In FIG. 9, though only the searched domain names are indicated, index words registered by the administrator are indicated with the searched domain names so that user selects a required site easily.

Consequently, the method for searching for the domain in Internet according to the present invention indicates domain names in alphabetic or numeric order as a telephone directory so that the user confirms the domain names clearly.

Especially, the corresponding domain is found only by the characteristics of the domain names so that a required site is found rapidly.

The effects of the present invention could be summarized as follows.

The method for searching for the domain in Internet according to the present invention the users understand domain names at a glance by indicating them in alphabetic or numeric order as a dictionary so that the users move to the required site.

The users could confirm the entire related domain names so that the user perform the search easily using the characteristics of the domain name as knowing a part of the domain name.

In registration of the domain name, since similar domain names are verified in alphabetic or numeric order, the site administrator could refer to them in determining the its domain name.

As the various index word are entered in registering the operated site in the search service site, the users could find the related sites easily only with the search by the index word representing the site characteristics.

In indicating the domain names, since detailed advertisements such as a size of characters, different colors and an indication of adjacent advertisement, and a partial hyperlink are available, it could be applied to the site not a simple banner but also various advertisements or a different charge.

It will be apparent to those skilled in the art that various modifications and variations can be made in the fin tube type evaporator in an air conditioner of the present invention without departing from the spirit or scope of the invention. Thus, it is intended that the present invention cover the modifications and variations of this invention provided they come within the scope of the appended claims and their equivalents.

What is claimed is:

1. A method for searching for domain comprising:
(a) building a search service site and leading an administrator of many other site to register a certain domain name;
(b) requesting a search by entering the domain name as a key word in a domain search engine after an Internet user is connected to the search service site built in the step (a);
(c) verifying whether the domain name in the step (b) is included in all domain names registered in the step (a); and
(d) indicating all related domain names in alphabetic or numeric order including the domain having the key word in the step (c).

2. A method for searching for domain comprising:
(a) building a search service site and leading an administrator of many other site to register a certain domain name and enter a plurality of index words including a characteristics of own site in the registration;
(b) requesting a search by entering the index word in the search engine after an Internet user is connected to the search service site built in the step (a);
(c) verifying whether the index word in the step (b) is included in the index words registered in the step (a); and
(d) indicating all related domain names including the index word in the step (c) in alphabetic or numeric order.

3. A method according to claim 1, wherein the step (b) includes requesting the search by click of a hyperlink.

4. A method according to claim 2, wherein the step (b) includes requesting the search by click of a hyperlink.

5. A method for searching for domain comprising:
(a) entering a registration required domain name in a search window of a domain registration authority or domain registration service site to verify a pre-registration of the required domain name;
(b) indicating a message informing of a registration possibility or a pre-registration of the domain names entered in the step (a) in the domain registration authority or domain registration service site; and
(c) indicating all related domain names in alphabetic or numeric order including the domain having the key word in the step (a) from date of the domain registration authority or domain registration service site.
